(19) United States
(12) Patent Application Publication
(10) Pub. No.: US 2015/0113542 A1
(43) Pub. Date: Apr. 23, 2015

(54) KNAPSACK-BASED SHARING-AWARE SCHEDULER FOR COPROCESSOR-BASED COMPUTE CLUSTERS

(71) Applicant: NEC Laboratories America, Inc., Princeton, NJ (US)

(72) Inventors: Srihari Cadambi, Princeton Junction, NJ (US); Giuseppe Coviello, Plainsboro, NJ (US); Srimat Chakradhar, Manalapan, NJ (US)

(21) Appl. No.: 14/506,256

(22) Filed: Oct. 3, 2014

Related U.S. Application Data
(60) Provisional application No. 61/892,147, filed on Oct. 17, 2013.

(51) Int. Cl. G06F 9/52; H04L 29/08

(52) U.S. Cl. CPC G06F 9/52; H04L 67/10
USPC 718/107

(57) ABSTRACT

A method is provided for controlling a compute cluster having a plurality of nodes. Each of the plurality of nodes has a respective computing device with a main server and one or more coprocessor-based hardware accelerators. The method includes receiving a plurality of jobs for scheduling. The method further includes scheduling the plurality of jobs across the plurality of nodes responsive to a knapsack-based sharing-aware schedule generated by a knapsack-based sharing-aware scheduler. The knapsack-based sharing-aware schedule is generated to co-locate together on a same computing device certain ones of the plurality of jobs that are mutually compatible based on a set of requirements whose fulfillment is determined using a knapsack-based sharing-aware technique that uses memory as a knapsack capacity and minimizes makespan while adhering to coprocessor memory and thread resource constraints.

### RELATED APPLICATION INFORMATION

This application claims priority to provisional application Ser. No. 61/892,147 filed on Oct. 17, 2013, incorporated herein by reference.

### BACKGROUND

1. Technical Field

The present invention relates to data processing, and more particularly to a knapsack-based sharing-aware scheduler for coprocessor-based compute clusters.

2. Description of the Related Art

There is a problem of utilization in high performance compute clusters that use certain coprocessors such as the Xeon Phi coprocessor. Even though the coprocessor runs Linux, current cluster managers typically exclusively allocate coprocessors to jobs in order to avoid several adverse effects such as process crashes and extreme performance loss. Such an exclusive allocation policy reduces the efficiency of coprocessor usage. For example, we have measured average coprocessor core occupancy rates of as low as 38%. The reduced efficiency results in increased cluster footprint and high operating costs.

Current high performance cluster managers generally use an “exclusive allocation” policy, where a Xeon Phi coprocessor is dedicated to a job for its lifetime. Cluster managers also allow sharing in some cases (where the administrator overrides the default exclusive allocation policy), but they do not decide which jobs can share without crashing or severely affecting performance. For clusters with a large number of coprocessor-intensive jobs, this results in low utilization and a cluster size that is larger than necessary, leading to an increase in operating costs.

### SUMMARY

These and other drawbacks and disadvantages of the prior art are addressed by the present principles, which are directed to a knapsack-based sharing-aware scheduler for coprocessor-based compute clusters.

According to an aspect of the present principles, a method is provided for controlling a compute cluster having a plurality of nodes. Each of the plurality of nodes has a respective computing device with a main server and one or more coprocessor-based hardware accelerators. The method includes receiving a plurality of jobs for scheduling. The method further includes scheduling the plurality of jobs across the plurality of nodes responsive to a knapsack-based sharing-aware schedule generated by a knapsack-based sharing-aware scheduler. The knapsack-based sharing-aware schedule is generated to co-locate together on a same computing device certain ones of the plurality of jobs that are mutually compatible based on a set of requirements whose fulfillment is determined using a knapsack-based sharing-aware technique that uses memory as a knapsack capacity and minimizes makespan while adhering to coprocessor memory and thread resource constraints.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 shows an exemplary system/method 100 for knapsack-based sharing-aware scheduling for coprocessor-based compute clusters; and

FIGS. 2-3 show a method for knapsack-based sharing-aware scheduling for coprocessor-based compute clusters, in accordance with an embodiment of the present principles.

### DETAILED DESCRIPTION OF PREFERRED EMBODIMENTS

The present principles are directed to a knapsack-based sharing-aware scheduler for coprocessor-based compute clusters. One or more embodiments of the present principles advantageously address the aforementioned problem of utilization in high performance compute clusters that use the Xeon Phi coprocessor. However, while some embodiments described herein are described with respect to the Intel Xeon Phi® coprocessor, it is to be appreciated that the teachings of the present principles can be applied to other coprocessors by those skilled in the art given the teachings of teachings of the present principles provided herein, while maintaining the spirit of the present principles. In an embodiment, the compute clusters include coprocessor based servers.

In an embodiment, a method is provided to decide which jobs should share each coprocessor in a high performance cluster. In an embodiment, the method can be a transparent add-on to existing cluster middleware and is invisible to users, applications as well as the underlying system software. In an embodiment, the decision is made at the cluster-level, and is based on the knapsack algorithm.

It is to be appreciated that the present principles are not restricted to jobs running sequentially on each node. Rather, the present principles allow concurrent job execution and consider coprocessor resource constraints such as, for example, but not limited to, memory and threads. In addition, the present principles do not require the user to specify job execution times.

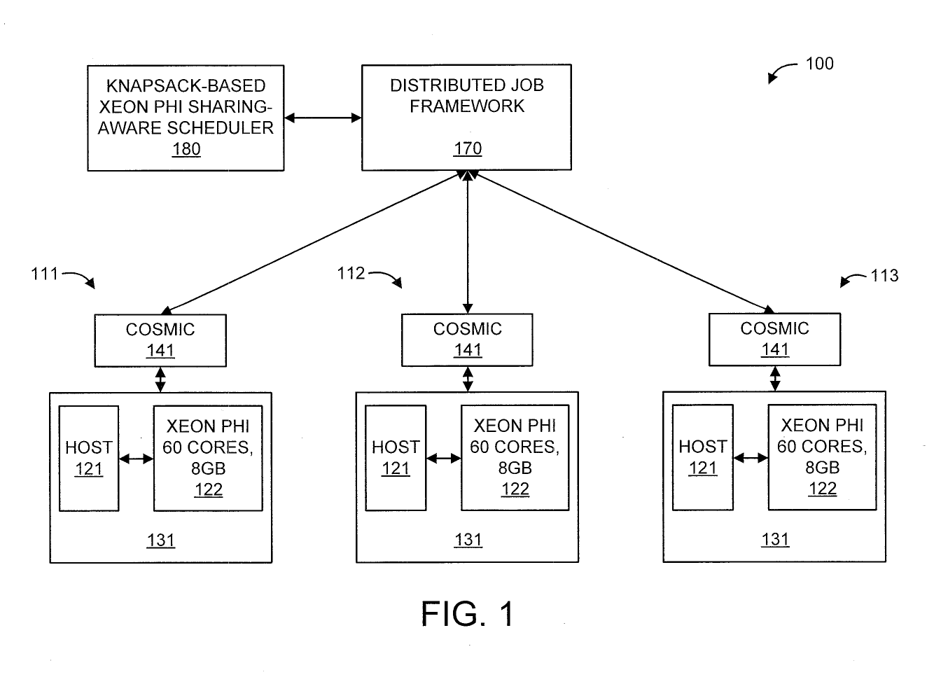

FIG. 1 shows an exemplary system/method 100 for knapsack-based sharing-aware scheduling for coprocessor-based compute clusters.

The system/method 100 includes a compute cluster 110 having a set of coprocessor-based server nodes 111, 112, and 113, interconnected by a network (not shown). Each of the nodes 111, 112, and 113 includes a respective computing device (hereinafter also referred to as “compute server”) 131, 132, 133. Each of the compute servers 131, 132, and 133 includes a respective host processor (hereinafter also referred to as “host” in short) 121, and a respective set of (one or more) hardware accelerators 122. In an embodiment, each hardware accelerator includes one or more coprocessors (e.g., multi-core coprocessors) 122A and corresponding memory 122B. In an embodiment, the coprocessors are Xeon Phi coprocessors (as shown). In an embodiment, the hardware accelerators are coprocessor-based accelerator cards. For the embodiment of FIG. 1, Xeon Phi co-processor based hardware accelerators are described. However, other configurations and implementations can also be used in accordance with the teachings of the present principles, while maintaining the spirit of the present principles.

Each of the nodes 111, 112, and 113 runs a respective instantiation of COSMIC (hereinafter “COSMIC) 141, which allows safe coprocessor sharing among multiple jobs. COSMIC 141 also coordinates jobs across multiple Xeon Phi co-processor cards in a given node. For example, COSMIC 141 will review memory requirements, the number of cores, and so forth, in order to perform job coordination across multiple cards. Each COSMIC 141 is node-based. Thus, each COSMIC 141 can coordinate jobs across one or more cards in a respective one of the nodes 111, 112, and 113 to which it is associated. Hence, for example, if one of nodes should have four Xeon Phi coprocessor accelerator cards 122, then the corresponding COSMIC 141 for that node can coordinate a job across (i.e., using) all four of the Xeon Phi coprocessor accelerator cards 122 in that node.

We can use an existing distributed job framework 170, to which jobs are submitted. In an embodiment, we use HTCondor as a distributed job framework and, hence, we interchangeably use the terms “distributed job framework” and “HTCondor” with respect to reference numeral 170. However, it is to be appreciated that the present principles are not limited to using HTCondor and, thus, other distributed job frameworks can also be used in accordance with the present principles, while maintaining the spirit of the present principles. In an embodiment, we plug our knapsack-based Xeon Phi sharing-aware scheduler 180 into HTCondor 170 so that all job scheduling decisions (i.e., which job must be scheduled when and to what node) are made by our scheduler 180.

While shown with one compute cluster, it is to be appreciated that the present principles can be used with one or more compute clusters. While each node is shown with a respective set of accelerator cards having one Xeon Phi accelerator card therein, as noted above, each set can include one or more Xeon Phi accelerator cards, while maintaining the spirit of the present principles. Moreover, in an embodiment, only some of the nodes can have one or more Xeon PHI accelerator cards therein, with other nodes having no accelerator cards or accelerator cards having a different coprocessor. These and other variations of the environment to which the present principles can be applied are readily determined by one of ordinary skill in the art given the teachings of the present principles provided herein, while maintaining the spirit of the present principles.

Given a set of jobs and a cluster of Xeon Phi-based compute servers (e.g., compute servers 131, 132, and 33), we decide a schedule for the jobs such that makespan is minimized. Jobs are allowed to run concurrently on the Xeon Phi coprocessor accelerator cards 122 as long as they do not oversubscribe memory and thread resources.

The knapsack-based approach allows us to consider both memory and thread constraints. We model the coprocessor-based cluster as a set of knapsacks each with a capacity, and schedule jobs such that the value of the filled knapsacks is maximized. Each Xeon Phi coprocessor accelerator card 122 in a compute server is a knapsack, and the items in it represent jobs that are concurrently running on that Xeon Phi coprocessor accelerator card 122. In an embodiment, the knapsack capacity is the physical memory of the Xeon Phi coprocessor accelerator card 122. The physical memory is a hard limit that concurrent jobs must not exceed since that will result in undesirable effects such as process crashes and extreme performance loss.

Our objective is to minimize makespan without knowledge of job execution times. In addition, we also do not know the profile of a job. Knowledge of these could result in an optimal makespan, but such knowledge is not commonly available. Therefore, our method sets the “value” of each job such that the knapsack approach tries to have as much Xeon Phi job concurrency as possible subject to resource constraints. Having more jobs running at the same time on the same device will increase the chances of Xeon Phi cores being well utilized, and decrease gaps in Xeon Phi usage of any job being filled. In addition, having many concurrently executing jobs also improves chances that a long running job (which affects the final makespan) will overlap with several other short jobs. We set the value of a job such that it decreases with the number of its threads. Therefore the knapsack algorithm will tend to pack many jobs with few threads. This enhances core and device utilization.

Specifically, the value vᵢ of job Jᵢ in our knapsack formulation is given by the following:

$${v}_{i} = 1 - {( \frac{{t}_{i}}{T} )}^{2}$$

where tᵢ is number of Xeon Phi threads requested by the job, and T is the total number of hardware threads supported by the Xeon Phi.

In order to avoid oversubscription, the number of threads of all concurrent jobs must not exceed the number of hardware threads supported by the Xeon Phi. The overall knapsack-based scheduling approach is shown in the pseudocode below. We start by creating a knapsack for each Xeon Phi device in each server and set the knapsack capacity to the full physical device memory. We fill all knapsacks initially, maximizing their value. When any device completes a job, we create a new knapsack whose capacity is set to the device memory that was freed up by the completed job. As long as unscheduled jobs exist, we fill each such new knapsack. This process continues until all jobs have been scheduled and completely executed.

An exemplary pseudo-code sequence is provided in accordance with an embodiment of the present principles as follows:

for each Xeon Phi device D in cluster do

pack jobs in D using knapsack algorithm

end for
while jobs remaining do

for each Xeon Phi D with free memory do

create knapsack: capacity = free memory in D
pack jobs in D using knapsack algorithm

end for

end while

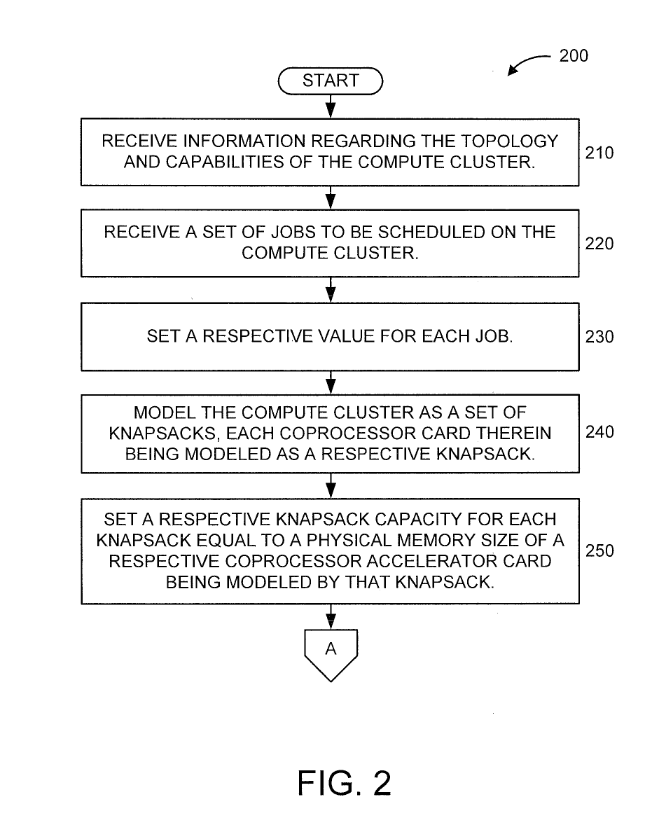

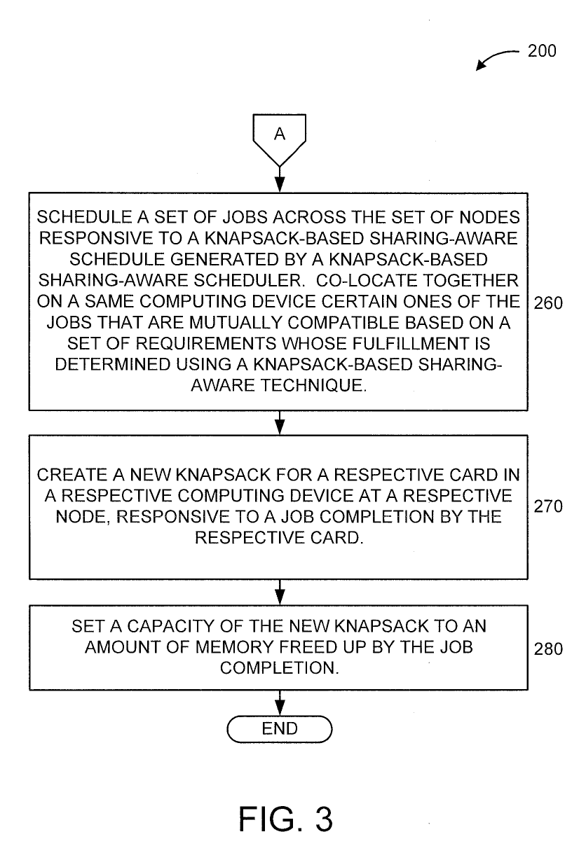

FIGS. 2-3 show a method for knapsack-based sharing-aware scheduling for a coprocessor-based compute cluster, in accordance with an embodiment of the present principles.

At step 210, receive information regarding the topology and capabilities of the compute cluster. The information can include the number of nodes, the number of coprocessor cards at each node, the number of cores of each coprocessor card, the amount of memory of each coprocessor card, and so forth.

At step 220, receive a set of jobs to be scheduled on the compute cluster.

At step 230, set a respective job value for each job. The job value can be set, for example, based on the number of threads requested by the job (when executed), and so forth. For example, in an embodiment, decrease the respective job value as the number of job-requested threads for that job increases. In an embodiment, the respective job value is calculated as follows:

$${v}_{i} = 1 - {( \frac{{t}_{i}}{T} )}^{2}$$

where vi is the respective job value of job i from among the plurality of jobs, tᵢ is number of threads requested by the job i, and T is the total number of hardware threads supported by the Xeon Phi.

At step 240, model the compute cluster as a set of knapsacks, with each coprocessor accelerator card therein being modeled as respective knapsack.

At step 250, set a respective knapsack capacity for each knapsack equal to a physical memory size of a respective coprocessor accelerator card being modeled by that knapsack.

At step 260, schedule the set of jobs across the set of nodes responsive to a knapsack-based sharing-aware schedule generated by a knapsack-based sharing-aware scheduler. The knapsack-based sharing-aware schedule is generated to co-locate together on a same computing device certain ones of the jobs that are mutually compatible based on a set of requirements (e.g., coprocessor accelerator card memory and thread resource constraints) whose fulfillment is determined using a knapsack-based sharing-aware technique. The knapsack-based sharing-aware technique generates the knapsack-based sharing-aware schedule responsive to the job values for the jobs. Thus, in an embodiment, mutually compatibility can be determined using the job values. The knapsack-based sharing-aware technique maximizes a fill value of each knapsack with respect to at least a portion of the set of requirements.

At step 270, create a new knapsack for a respective card in a respective computing device at a respective node, responsive to a job completion by the respective card.

At step 280, set a capacity of the new knapsack to an amount of memory freed up by the job completion.

A further description will now be given regarding COSMIC.

COSMIC is a transparent add-on to handle thread and memory oversubscription when multiple processes compete for the Xeon Phi within a single server node. Thread oversubscription occurs when the total number of threads across all jobs concurrently using the Xeon Phi exceeds the number of hardware threads.

COSMIC is architected to be lightweight and transparent to users of the Xeon Phi system. COSMIC interacts closely with both user processes and other kernel-level components, and controls offload scheduling and dispatch by intercepting Coprocessor Offload Infrastructure (COI) Application Programming Interface (API) calls. Every offload is converted by the Xeon Phi compiler into a series of COI calls, which are part of a standard API supported by INTEL. By intercepting these calls, COSMIC controls how offloads are scheduled and dispatched.

While one or more embodiments herein are described with respect to COSMIC, other sources of such information can also be used in accordance with the teachings of the present principles, while maintaining the spirit of the present principles.

A further description will now be given regarding HTCondor.

HTCondor is a cluster job scheduler for compute-intensive jobs. Users submit their jobs to HTCondor which places them in a queue and chooses when and where to run them based on policies. HTCondor provides a framework for matching job resource requests with available resources. A ClassAd mechanism allows each job to specify requirements (such as the amount of memory used) and preferences (such as a processor with more than 4 cores). It also allows cluster nodes to specify requirements and preferences about jobs they are willing to accept and run. Based on the ClassAds, HTCondor's matchmaking matches a pending job with an available machine. A HTCondor pool can include a single machine that serves as the central manager and all other cluster nodes. The central manager collects status information from all cluster nodes, and orchestrates matchmaking. To collect status information, it obtains ClassAd updates from each node. These updates include the state of the node such as currently available resources and load, and jobs that are executing on the node. The central manager then initiates a negotiation cycle during which all pending jobs are examined in First-In First-Out (FIFO) order, and matched with machines. A negotiation cycle is triggered periodically. Once a match is made, a shadow process is started on the machine where the job was submitted, and a starter process on the target machine. The shadow process transfers the job and associated data files to the target machine, where the starter process spawns the user application. When the job completes, the starter process removes all processes spawned by the user job and frees any temporary scratch spaces, leaving the machine in a clean state.

While one or more embodiments herein are described with respect to HTCondor, other sources of such information can also be used in accordance with the teachings of the present principles, while maintaining the spirit of the present principles.

A description will now be given regarding some of the many attendant inventive features of the present principles.

One such feature is scheduling jobs onto a Xeon Phi-based compute cluster such that multiple jobs execute concurrently on each coprocessor. To that end, such feature can include, but are not limited to, one or more of the following features: (1) using a knapsack-based approach to decide the job schedule based on minimizing makespan while adhering to coprocessor memory and thread resource constraints; (2) using the aforementioned value formulation for the knapsack algorithm; and (3) using memory as the knapsack capacity.

A description will now be given regarding some of the many attendant differences between the present principles and the prior art.

Regarding makespan scheduling, such differences include, but are not limited to, the following: (1) we specifically target coprocessor-based servers in a cluster; (2) we do not restrict jobs to run sequentially on each node (coprocessor), but allow concurrency; (3) we consider coprocessor memory and thread resource constraints for concurrent jobs; and (4) we do not require the user to specify job execution times.

A description will now be given regarding some of the many attendant benefits/advantages provided by the present principles over the prior art.

The formulation of the knapsack-based approach described earlier allows us to holistically consider resource constraints together with job concurrency, while not relying on job execution times. While specifying job execution times can provide a more accurate schedule (with a lower makespan), it is not realistic, and our knapsack-based approach comes close to the optimal.

A description will now be given regarding some of the many attendant competitive/commercial values of the solution provided by the present principles.

The inclusion of the present principles into existing infrastructure for high-performance coprocessor-based clusters will reduce the size of the cluster (or footprint) required for processing coprocessor-intensive jobs. This will directly result in reduced operating costs.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable medium such as a semiconductor or solid state memory, magnetic tape, a removable computer diskette, a random access memory (RAM), a read-only memory (ROM), a rigid magnetic disk and an optical disk, etc.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. Additional information is provided in an appendix to the application entitled, “Additional Information”. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for controlling a compute cluster having a plurality of nodes, each of the plurality of nodes having a respective computing device with a main server and one or more coprocessor-based hardware accelerators, the method comprising:
receiving a plurality of jobs for scheduling; and
scheduling the plurality of jobs across the plurality of nodes responsive to a knapsack-based sharing-aware schedule generated by a knapsack-based sharing-aware scheduler,
wherein the knapsack-based sharing-aware schedule is generated to co-locate together on a same computing device certain ones of the plurality of jobs that are mutually compatible based on a set of requirements whose fulfillment is determined using a knapsack-based sharing-aware technique that uses memory as a knapsack capacity and minimizes makespan while adhering to coprocessor memory and thread resource constraints.

2. The method of claim 1, wherein the knapsack-based sharing-aware technique comprises modeling the compute cluster as a plurality of knapsacks, each of the one or more coprocessor-based hardware accelerators being modeled as respective one of the plurality of knapsacks.

3. The method of claim 2, wherein the knapsack-based sharing-aware technique further comprises maximizing a fill value of each of the plurality of knapsacks with respect to at least a portion of the set of requirements.

4. The method of claim 3, wherein the fill value is maximized using an objective function.

5. The method of claim 2, wherein a respective knapsack capacity for a respective one of the plurality of knapsacks is set equal to a physical memory size of a respective one of the one or more coprocessor-based hardware accelerators being modeled by the respective one of the plurality of knapsacks.

6. The method of claim 5, wherein the set of requirements comprise each of the plurality of knapsacks having a memory utilization limited by the physical memory size of a corresponding one of the one or more coprocessor-based hardware accelerators being modeled thereby.

7. The method of claim 1, further comprising setting a respective job value for each of the plurality of jobs, and wherein the knapsack-based sharing-aware technique generates the knapsack-based sharing-aware schedule responsive to the respective job value for each of the plurality of jobs.

8. The method of claim 7, wherein said setting step comprises decreasing the respective job value for a respective one of the plurality of jobs as a number of job-requested threads for the respective one of the plurality of jobs increases.

9. The method of claim 7, wherein the respective job value is calculated as follows:
$${v}_{i} = 1 - {( \frac{{t}_{i}}{T} )}^{2}$$
where vi is a respective job value of job i from among the plurality of jobs, tᵢ is number of coprocessor requested threads by the job i, and T is a total number of coprocessor supported hardware threads.

10. The method of claim 1, wherein the knapsack-based sharing-aware schedule is generated to co-locate the certain ones of the plurality of jobs on multiple ones of the one or more coprocessor-based hardware accelerators of the same computing device.

11. The method of claim 1, wherein the knapsack-based sharing-aware schedule is generated to co-locate together on the same computing device the certain ones of the plurality of jobs that maximize a number of utilized cores on the same computing device.

12. The method of claim 1, wherein the knapsack-based sharing-aware schedule is generated to co-locate together on the same computing device the certain ones of the plurality of jobs that maximize a number of utilized cores on at least one of the one or more coprocessor-based hardware accelerators in the same computing device.

13. The method of claim 1, wherein the set of requirements comprise adhering to the coprocessor memory and thread resource constraints.

14. The method of claim 1, further comprising:
creating a new knapsack for a respective card from among the one or more coprocessor accelerator cards in the respective computing device at a respective one of the plurality of nodes, responsive to a job completion of a given one of the plurality of jobs by the respective card;
setting a capacity of the new knapsack to an amount of memory freed up by the job completion.

15. The method of claim 1, wherein the coprocessor-based hardware accelerators are multi-core coprocessor-based accelerator cards with corresponding cache memory.

16. A non-transitory article of manufacture tangibly embodying a computer readable program which when executed causes a computer to perform the steps of claim 1.
